(19) United States
(12) Patent Application Publication
(10) Pub. No.: US 2019/0297858 A1
(43) Pub. Date: Oct. 3, 2019

(54) PORTABLE REFRIGERATION UNIT

(71) Applicant: Jerry Wayne Tharp, Ocean Springs, MS (US)

(72) Inventor: Jerry Wayne Tharp, Ocean Springs, MS (US)

(21) Appl. No.: 16/369,765

(22) Filed: Mar. 29, 2019

Related U.S. Application Data
(60) Provisional application No. 62/649,704, filed on Mar. 29, 2018.

(51) Int. Cl. A01K 63/02; A01K 63/00; F25D 3/08; F25D 11/00; F25D 23/06

(52) U.S. Cl. CPC A01K 63/02; A01K 63/006; F25D 2500/00; F25D 11/003; F25D 23/06; F25D 3/08

(57) ABSTRACT

A portable refrigeration unit includes a drain tank having an open top. A grate is coupled to the top of the drain tank and covers the open top. A sidewall is upstanding from the drain tank. A top tray is coupled to a top edge of the sidewall. The top tray includes a recess and a plurality of drain holes. An ice basket includes a plurality of drain openings. The ice basket is removeably nested within the recess of the top tray. Shell fish are placed inside the portable refrigeration unit and rest on the grate. The ice basket is loaded with ice and placed within the top tray. As the ice melts, cold water drips through the ice basket and the top tray, and onto the shell fish. The cold water drains through the grate and into the tank.

### CROSS-REFERENCE TO RELATED APPLICATION

This application claims the benefit of priority of U.S. provisional application No. 62/649,704, filed Mar. 29, 2018, the contents of which are herein incorporated by reference.

### BACKGROUND OF THE INVENTION

The present invention relates to refrigeration, more particularly, to a portable refrigeration unit to contain live shell fish.

Blue crabs, crawfish, lobsters and other shell fish are very difficult to keep alive due to variance in temperature and moisture. Current containers create an environment detrimental to keeping shell fish alive for an extended amount of time and increases death rate.

As can be seen, there is a need for an improved portable refrigeration unit for keeping crabs, crawfish and other seafood alive.

### SUMMARY OF THE INVENTION

In one aspect of the present invention, a portable refrigeration unit comprises: a drain tank comprising an open top; a grate coupled to the drain tank and covering the open top; a sidewall upstanding from the drain tank; a top tray coupled to a top edge of the sidewall, the top tray comprising a recess and a plurality of drain holes; and an ice basket comprising a plurality of drain openings, the ice basket removeably nesting within the recess of the top tray.

In another aspect of the present invention, a portable refrigeration unit comprises: a drain tank comprising an open top; a grate coupled to the drain tank and covering the open top; a sidewall upstanding from the drain tank and comprising an access opening defined by an inner edge; a top tray coupled to a top edge of the sidewall, the top tray comprising a recess and a plurality of drain holes; and an ice basket comprising a plurality of drain openings, the ice basket removeably nesting within the recess of the top tray.

These and other features, aspects and advantages of the present invention will become better understood with reference to the following drawings, description and claims.

### BRIEF DESCRIPTION OF THE DRAWINGS

FIG. 1 is a rear perspective view of an embodiment of the present invention, shown in use;

FIG. 2 is a cross-sectional view of the present invention, taken along line 2-2 in FIG. 1;

FIG. 3 is a perspective view of an embodiment of the present invention;

FIG. 4 is an exploded view of an embodiment of the present invention;

FIG. 5 is a perspective view of an embodiment of the present invention; and

FIG. 6 is a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a waterless aquarium for keeping blue crabs, lobsters, and crawfish alive for extended periods of time. The present invention provides for lower temperatures and the right amount of moisture to keep the shellfish alive. The container produces a way to control temperature and maintain moisture content for an extended amount of time.

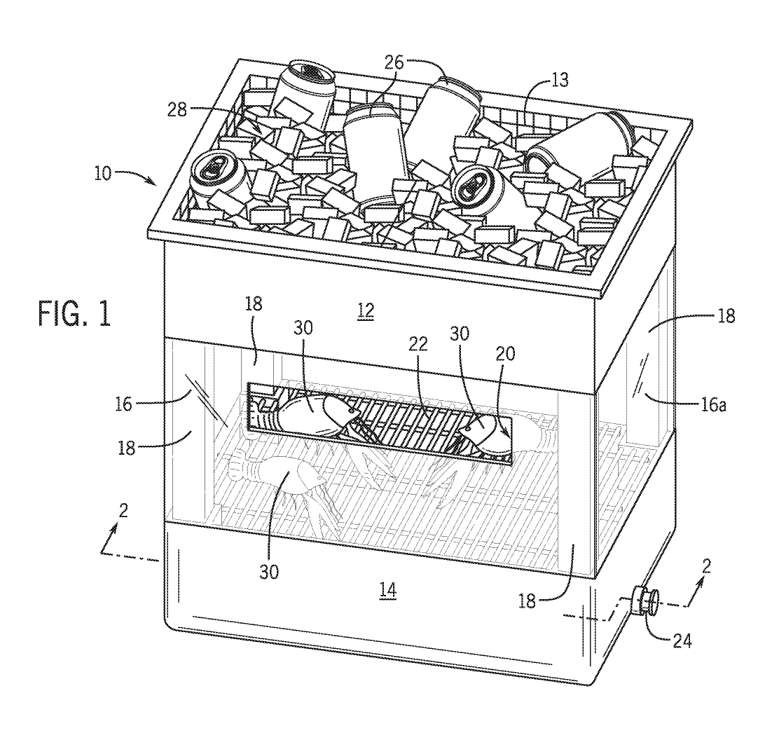

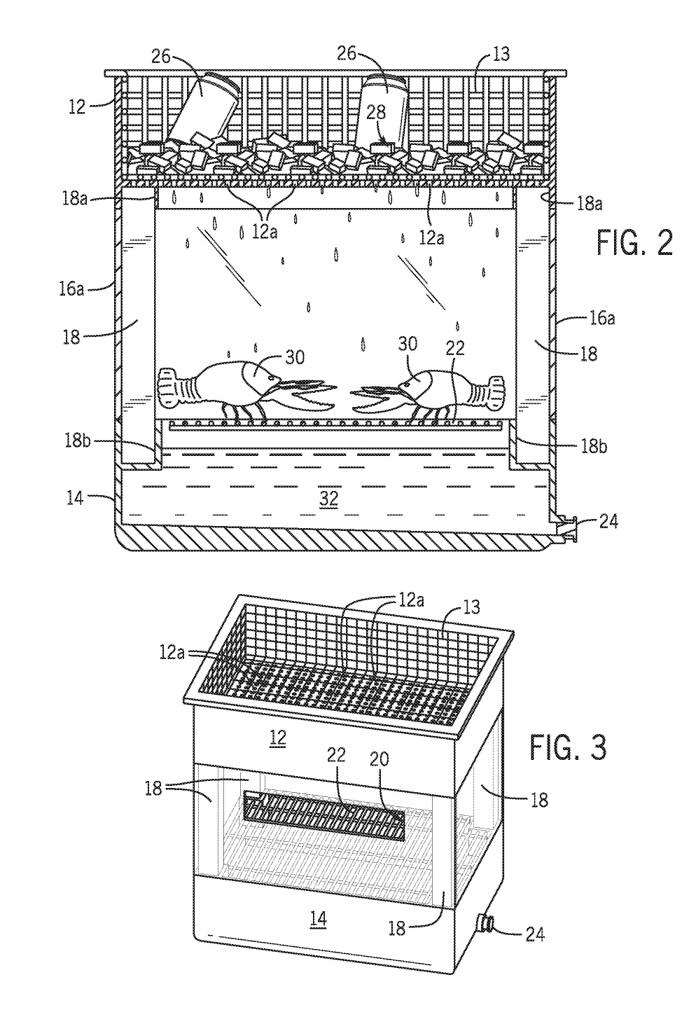

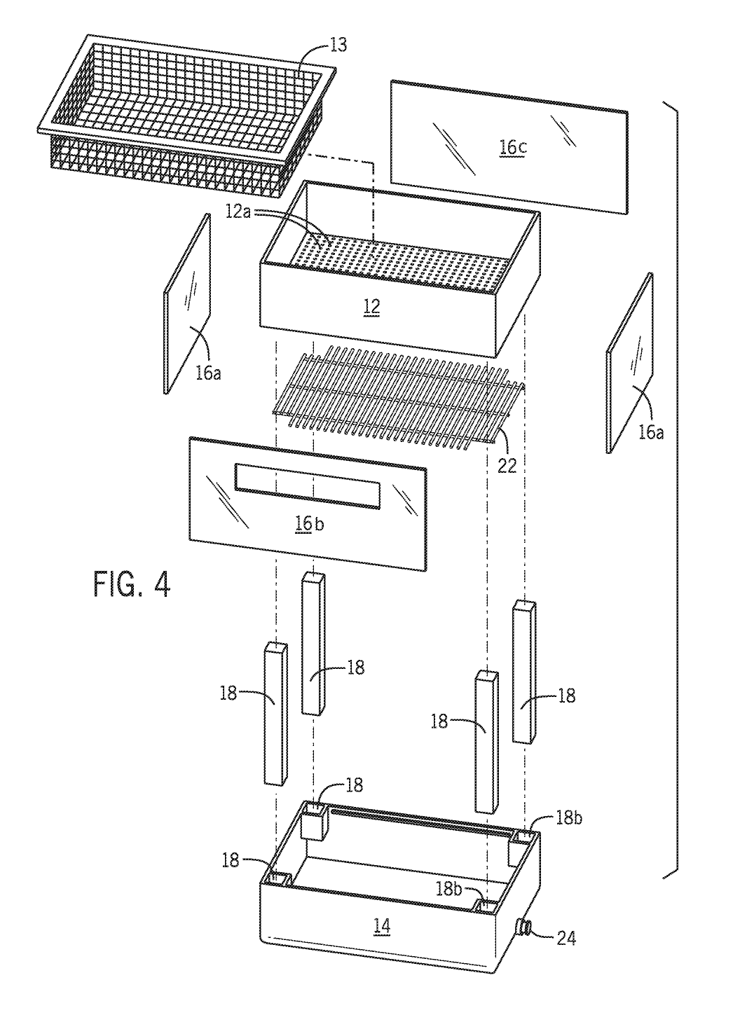

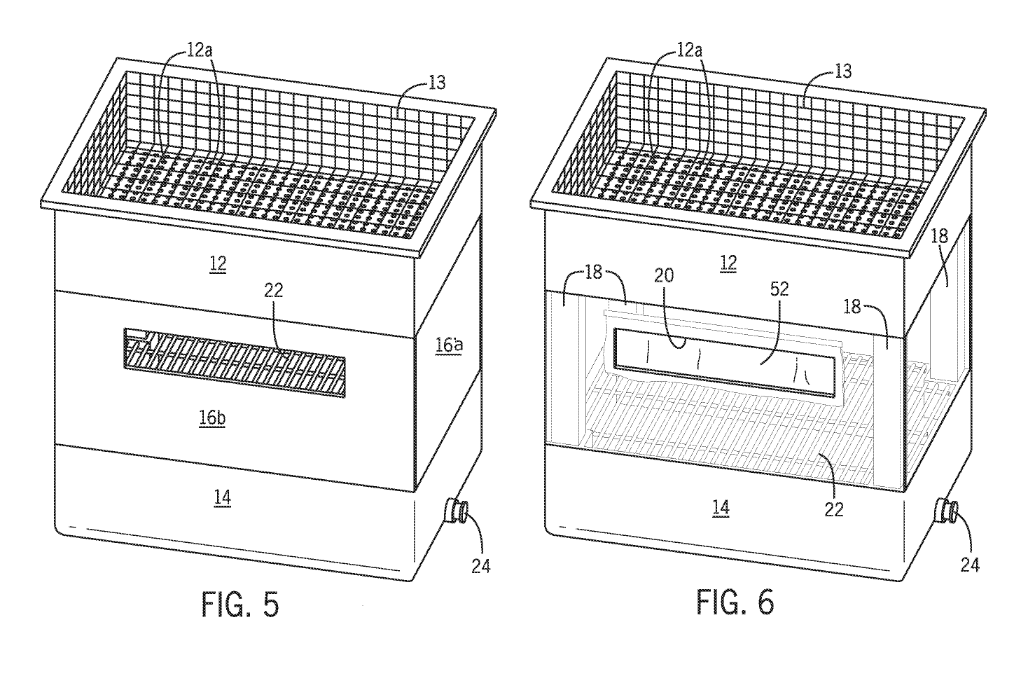

Referring to FIGS. 1 through 6, the present invention includes a portable refrigeration unit 10. The portable refrigeration unit 10 includes a drain tank 14 having an open top. A grate 22 is coupled to the top of the drain tank 14 and covers the open top. A sidewall 16 is upstanding from the drain tank 14. A top tray 12 is coupled to a top edge of the sidewall 16. The top tray 12 includes a recess and a plurality of drain holes 12a. An ice basket 13 includes a plurality of drain openings. The ice basket 13 is removeably nested within the recess of the top tray 12. Shell fish 30 are placed inside the portable refrigeration unit 10 and rest on the grate 22. The ice basket 10 is loaded with ice 28 and placed within the top tray 12. As the ice melts, cold water 32 drips through the ice basket 10 and the top tray 12, and onto the shell fish 30. The cold water 32 drains through the grate 22 and into the tank 14.

The drain tank 14 of the present invention includes a base and upstanding sidewalls extending from the perimeter of the base. The drain tank 14 is configured to store water 32 within. In certain embodiments, the drain tank 14 includes a drainage valve 24 fluidly connecting the inside of the drain tank 14 with the outside. Therefore, water 32 within the drain tank 14 may be easily drained. An inside surface of the drain tank 14 may include a ledge. The grate 22 may rest on the ledge. In alternate embodiments, the drain tank 14 can be bottomless and curtains can be used instead of the sidewalls. In such embodiments, the drain tank 14 may rest on a movable cart that has wheels.

The sidewall 16 of the present invention may include a front panel 16b, side panels 16a, and a rear panel 16c coupled together and coupled to the top edge of the drain tank 14. The sidewall 16 may be made of an insulating material to maintain a level temperature within the portable refrigeration unit 10. For example, the sidewall 16 may include a plurality of acrylic panels interlocked together. The sidewall 16 may be transparent so that a user may monitor the shellfish 30 that are inside of the portable refrigeration unit 10. Alternatively, as illustrated in FIG. 6, the sidewall 16 may not be transparent.

The sidewall 16 may further include an access opening 20 defined by an inner edge. The access opening 20 is sized to fit a human hand therethrough. Therefore, a user may reach in and remove or add shellfish to the inside of the portable refrigeration 10. As illustrated in FIG. 6, a curtain 52 is coupled to the sidewall 16 and covers the access opening 20. The curtain 52 drapes over the access opening 20. The curtain 52 may be made of an insulating material, so that cold air does not escape through the access opening 50.

As mentioned above, the top tray 12 is coupled to the top edge of the sidewall 16. The top tray 12 may include a base and upstanding sidewalls along the perimeter of the base. The upstanding sidewalls define the recess therebetween. The plurality of drain holes 12a are formed through the base. The ice basket 13 may have a similar shape as the top tray 12 and may nest within the top tray 12. The basket 13 may be made of a plurality of criss-crossing wires, defining drain openings therebetween. A user may place ice 28 as well as beverages 26 within the basket 13 and place the basket within the top tray 12 while in use.

In certain embodiments, the present invention may include a plurality of upstanding posts 18 coupled to the drain tank 14 and supporting the top tray 12. In such embodiments, the drain tank 14 includes sockets 18b at each corner. Bottom ends of the upstanding posts 18 are disposed within each of the sockets 18b. Additionally, the top tray 12 may include sockets 18a. The top ends of each of the upstanding posts 18 may be disposed within each of the sockets 18a of the top tray 12, connecting the top tray 12 to the drain tank 14.

It should be understood, of course, that the foregoing relates to exemplary embodiments of the invention and that modifications may be made without departing from the spirit and scope of the invention as set forth in the following claims.

What is claimed is:

1. A portable refrigeration unit comprising:
a drain tank comprising an open top;
a grate coupled to the drain tank and covering the open top;
a sidewall upstanding from the drain tank;
a top tray coupled to a top edge of the sidewall, the top tray comprising a recess and a plurality of drain holes; and
an ice basket comprising a plurality of drain openings, the ice basket removeably nesting within the recess of the top tray.

2. The portable refrigeration unit of claim 1, further comprising a drainage valve coupled to the drain tank.

3. The portable refrigeration unit of claim 1, wherein the sidewall is transparent.

4. The portable refrigeration unit of claim 1, wherein the sidewall comprises an access opening defined by an inner edge.

5. The portable refrigeration unit of claim 4, further comprising a curtain coupled to the sidewall and covering the access opening.

6. The portable refrigeration unit of claim 1, further comprising a plurality of upstanding posts coupled to the drain tank and supporting the top tray.

7. A portable refrigeration unit comprising:
a drain tank comprising an open top;
a grate coupled to the drain tank and covering the open top;
a sidewall upstanding from the drain tank and comprising an access opening defined by an inner edge;
a top tray coupled to a top edge of the sidewall, the top tray comprising a recess and a plurality of drain holes; and
an ice basket comprising a plurality of drain openings, the ice basket removeably nesting within the recess of the top tray.

8. The portable refrigeration unit of claim 7, further comprising a curtain coupled to the sidewall and covering the access opening.

9. The portable refrigeration unit of claim 7, further comprising a drainage valve coupled to the drain tank.

10. The portable refrigeration unit of claim 7, wherein the sidewall is transparent.
